(19) United States
(12) Patent Application Publication
(10) Pub. No.: US 2017/0343131 A1
(43) Pub. Date: Nov. 30, 2017

(54) UNIVERSAL HOSE BIB HANDLE ADAPTER

(71) Applicant: Kevin Albrecht, Chino Hills, CA (US)

(72) Inventor: Kevin Albrecht, Chino Hills, CA (US)

(21) Appl. No.: 15/680,206

(22) Filed: Aug. 18, 2017

(51) Int. Cl. F16K 31/60

(52) U.S. Cl. CPC F16K 31/607

(57) ABSTRACT

Disclosed is a universal hose bib handle adapter which includes a bottom portion, plurality of anchor screws, and a threaded portion. The bottom portion detachably attached to at least one of a stem, or broach of a hose bib. The plurality of anchor screws having pre-defined dimensions with surface points adaptable to provide a harmonize placing in between the bottom portion and the broach. In an embodiment, the anchor screws are removably configured with the bottom portion through a plurality of corresponding anchor holes. The threaded portion adaptable to receive a decorative handle, wherein the threaded portion is milled with the bottom portion to increase a strength of the threaded portion.

### TECHNICAL FIELD

The present invention generally relates to a universal hose bib handle, adapter and specifically relates to a universal hose bib adapter with a replaceable decorative handle.

### BACKGROUND

Traditional faucets include at least one faucet handle which is rotated to open and close a valve for controlling the flow of water to a delivery spout. The faucet handle is coupled to the valve stem. In case the faucet handle is damaged then finding a faucet handle which will fit into the existing valve stem is cumbersome because of the various shapes and sizes of the valve stem such as square, round, threaded, metric, standard, keyhole etc. Further, the threaded and welded attachments require complete replacement of the hose bib, and plumbing knowledge to replace the handle with a decorative handle.

Existing universal hose bib adapters require the specific valve stems, for example, universal faucet handle structure as disclosed in U.S. Pat. No. 8,832,905 B2, requires the existing stern use a threaded attachment. If the stem is not threaded, then the components disclosed in the U.S. Pat. No. 8,832,905 B2 do not work. Further, the existing universal hose bib adapters and methods require a person expert in the plumbing work, possibly welding knowledge and operational knowledge of the plumbing fixtures in a home. Further, the existing universal hose bib adapters fail to evenly distribute the torque of set screws to secure the adapter and to provide an adapter which is readily adhered or be combined with various decorative fixtures.

Therefore there is a need for a universal hose handle bib adapter which can be operated by an average user to change the handle to without removing the entire fixture. Further, there is also a need for a universal hose bib adapter which enables the user to change the decoration by unscrewing the interchangeable decorative handle without tools, or plumbing knowledge.

Further limitations and disadvantages of conventional and traditional approaches will become apparent to one of skill in the art through comparison of described systems with some aspects of the present disclosure, as set forth in the remainder of the present application and with reference to the drawings.

### SUMMARY OF THE INVENTION

The present invention mainly solves the technical problems of the existing prior art. In response to these problems, the present invention provides a universal hose bib handle adapter, as shown in and/or described in connection with at least one of the figures, as set forth more completely in the claims.

The universal hose bib handle adapter includes a bottom portion, plurality of anchor screws, and a threaded portion. The bottom portion detachably attached to at least one of a stem, or broach of a hose bib. The plurality of anchor screws having pre-defined dimensions with surface points adaptable to provide a harmonize placing in between the bottom portion and the broach. In an embodiment, the anchor screws are removably configured with the bottom portion through a plurality of corresponding anchor holes. The threaded portion adaptable to receive a decorative handle, wherein the threaded portion is milled with the bottom portion to increase the strength of the threaded portion.

These features and advantages of the present disclosure may be appreciated by reviewing the following description of the present disclosure, along with the accompanying figures wherein like reference numerals refer to like parts.

### BRIEF DESCRIPTION OF DRAWINGS

The accompanying drawings illustrate the embodiments of systems, methods, and other aspects of the disclosure. Any person with ordinary skills In the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates an exploded view of the components of the present universal hose, bib handle adapter, in accordance with at least one embodiment;

FIG. 2 illustrates an assembly view of the universal hose bib adapter with a decorative handle, in accordance with at least one embodiment;

FIG. 3 illustrates an operational view of the present universal hose bib handle adapter, in accordance with at least one embodiment; and

FIG. 4 illustrates an exemplary view of the various decorative handles, in accordance with at least one embodiment.

### DETAILED DESCRIPTION OF PREFERRED EMBODIMENTS

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment”, “at least one embodiment”, “an embodiment”, “one example”, “an example”, “for example”, and so on indicate that the embodiment(s) or example(s) may include a particular feature, structure, characteristic, property, element, or limitation, but not every embodiment or example necessarily include that particular feature, structure, characteristic, property, element, or limitation. Furthermore, repeated use of the phrase “in an embodiment” does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described. All publications, patents, and patent applications mentioned herein are incorporated in their entirety.

It is noted that as used herein and in the appended claims, the singular forms “a”, “and”, and “the” include plural referents unless the context clearly dictates otherwise. In the claims, the terms “first”, “second”, and so forth are to be interpreted merely as ordinal designations; they shall not be limited in themselves. Furthermore, the use of exclusive terminology such as “solely”, “only”, and the like in connection with the recitation of any claim element is contemplated. It is also contemplated that any element indicated to be optional herein may be specifically excluded from a given claim by way of a “negative” limitation. Finally, it is contemplated that any optional feature of the inventive variation(s) described herein may be set fourth and claimed independently or in combination with any one or more of the features described herein.

All references cited herein, including publications, patent applications, and patents, are hereby incorporated by reference to the same extent as if each reference were individually and specifically indicated to be incorporated by reference, and were set forth in its entirety herein.

The recitation of ranges of values herein is merely intended to serve as a shorthand method of referring individually to each separate value falling within the range, unless otherwise indicated herein, and each separate value is incorporated into the specification as if it were individually recited herein.

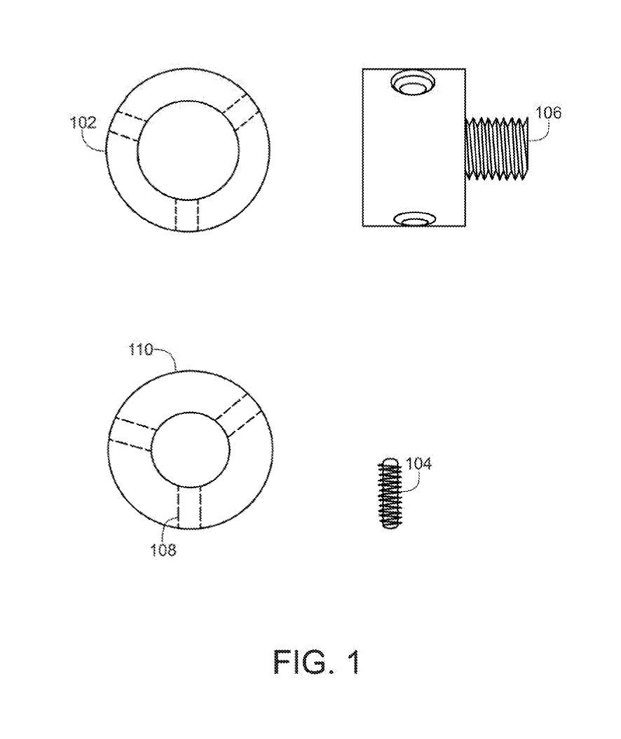

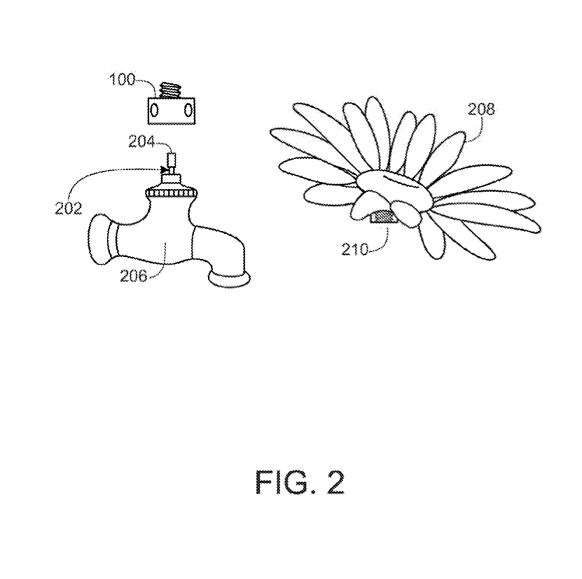

FIG. 1 illustrates an exploded view of the components of the present universal hose bib handle adapter 100, in accordance with at least one embodiment. The universal hose bib handle adapter includes a bottom portion 102, a plurality of anchor screws 104, and a threaded portion 106. The bottom portion 102 detachably attached to at least one of a stem 202 (shown in FIG. 2), or broach 204 (shown in FIG. 2) of a hose bib 206 (shown in FIG. 2). The plurality of anchor screws 104 having pre-defined dimensions with surface points adaptable to provide a harmonize placing in between the bottom portion 102 and the broach 204. The pre-defined dimension of the anchor screw 104 is at least as much to maintain adhesion to the stem onto which the present universal hose bib adapter 100 is intended to adhere.

In an embodiment, the anchor screws 104 are removably configured with the bottom portion 102 through a plurality of corresponding anchor holes 108. Each of the anchor hole 10$ is placed 120 degrees off center from opposing anchor holes 108 to provide even distribution of torque of the plurality of corresponding anchor screws 104. The threaded portion 106 adaptable to receive a decorative handle 208 (shown in FIG. 2). In an embodiment, the threaded portion 106 is milled with the bottom portion 102 to increase the strength of the threaded portion 106. The decorative handle 208 is mounted on the threaded portion 106 through a female threading mechanism.

FIG. 2 illustrates an assembly view of the universal hose bib adapter 100 with a decorative handle 208, in accordance with at least one embodiment. FIG. 2 is explained in conjunction with. FIG. 1. The universal hose bib adapter 100 connects to the stem 202 of the existing hose bib 206 and broach 204 from the bottom portion 102 via three set of anchor screws 104. The dimension preferably the diameter of the anchor screw is such that the surface area of the specified anchor screws 104 keeps the universal hose bib adapter 100 in place. The top portion 110 (shown in FIG. 1) of the present universal hose bib adapter 100 includes an easy mount threaded receiver 210 that allows the addition of a decorative handle 208 or a decorative fixture with the same threading.

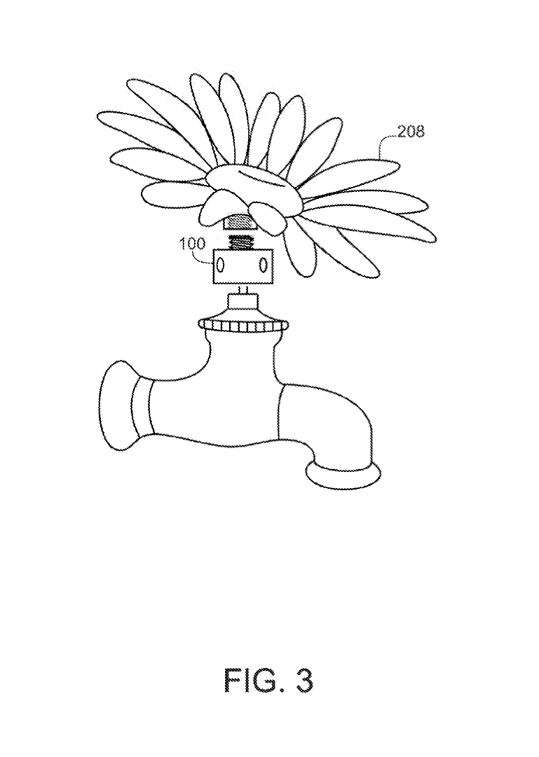

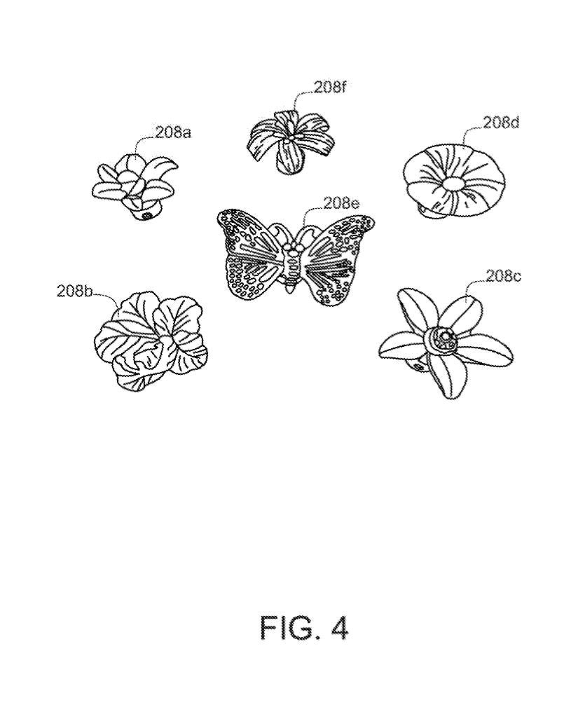

FIG. 3 illustrates an operational view of the present universal hose bib handle adapter 100, in accordance with at least one embodiment. The design of the present universal hose bib adapter 100 enables a user to easily affix to multiple stems 202 and multiple broaches 204 and multiple decorative fixtures 208. FIG. 4 illustrates an exemplary view of the various decorative handles 108a, 208b, 208c, 208d, 208e, and 208f, in accordance with at least one embodiment.

Thus the present universal hose bib handle adapter 100 allows the user to change the handle of the hose bib 206 with a simple hand tool with no plumbing knowledge. Additionally, the user can change the decoration by unscrewing the interchangeable decorative fixtures 208 without tools. Further, the present universal hose bib adapter 100 evenly distributes the torque of the anchor screws 104 to secure the present universal hose bib adapter. Furthermore, the present universal hose bib adapter 100 readily adheres the multiple decorative fixtures 208.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the appended claims. Thus, it is intended that the present invention covers the modifications and variations of this invention, provided they are within the scope of the appended claims and their equivalents.

1. A universal hose bib handle adapter comprising:
a bottom portion detachably attached to at least one of a stem or a broach of a hose bib;
a plurality of anchor screws having pre-defined dimensions with surface points adaptable in provide a harmonize placing in between the bottom portion and the broach, wherein the anchor screws are removably configured with the bottom portion through a plurality of corresponding anchor holes; and
a threaded portion adaptable to receive a decorative handle, wherein the threaded portion is milled with the bottom portion to increase a strength of the threaded portion.

2. The universal hose bib handle adapter according to claim 1, wherein the predefined dimension is such that surface area of the anchor screws keep the universal hose bib adapter secure to the broach or the stem.

3. The universal hose bib handle adapter according to claim 1, wherein the plurality of anchor holes are placed 120 degrees off center from opposing anchor holes to provide even distribution of torque of the plurality of corresponding anchor screws.

4. The universal hose bib handle adapter according to claim 1, wherein the decorative handle is mounted on the threaded portion through a female threading mechanism.
